(19) United States
(12) Patent Application Publication
(10) Pub. No.: US 2023/0071080 A1
(43) Pub. Date: Mar. 9, 2023

(54) ELECTRODE COMPOSITIONS

(71) Applicant: NYOBOLT LIMITED, Cambridge (GB)

(72) Inventors: Sai Shivareddy, Cambridge (GB); Clare Grey, Cambridge (GB)

(21) Appl. No.: 17/768,649

(22) PCT Filed: Oct. 16, 2020
(86) PCT No.: PCT/EP2020/079253

§ 371 Date: Apr. 13, 2022

(30) Foreign Application Priority Data
Oct. 16, 2019 (GB) 1914983.0

(51) Int. Cl. H01M 4/485; H01M 4/583; H01M 10/44; H01M 4/36; H01M 10/0525

(52) U.S. Cl. CPC H01M 4/485; H01M 4/583; H01M 10/44; H01M 4/366; H01M 10/0525; H01M 2004/027

(57) ABSTRACT

The present invention provides an electrode having a surface layer of niobium-containing metal oxide disposed on a secondary active electrode material. The niobium-containing metal oxide may be a Nb₂O₅ polymorph, NbO₂ or Nb₂O₃, or it may be a mixed metal oxides such as niobium tungsten oxide, titanium niobium oxide or niobium molybdenum oxide. Also provide is an electrochemical cell comprising the electrode, and the use of the cell, for example in a lithium ion battery, at elevated or reduced temperatures.

### RELATED APPLICATION

This present case is related to, and claims the benefit of, GB 1914983.0 filed on 16 Oct. 2019, the contents of which are hereby incorporated by reference in their entirety.

### FIELD OF THE INVENTION

The present invention provides an electrode and an electrochemical cell, such as a lithium ion battery, comprising the electrode, together with methods for using the electrode within the electrochemical cell.

### BACKGROUND

Lithium ion batteries are widely designed for optimal operation in temperatures between 15° C. and 40° C. The main limitations for this operation result from the materials used in the positive and negative electrodes and the lithium ion containing electrolyte. Under such optimal conditions, properties such as specific energy, specific power, cycle life, shelf life and safety related to the battery performance are maximised.

Changes to the temperature of operation of lithium ion batteries beyond this typical range limits their performance in energy, power, cycle life and safety. The changes usually arise due to external factors such as seasons and climatic conditions. However, temperature changes also arise from utilisation of the battery for its intended use in portable electronic applications like mobile phones, laptops and power tools or in electric vehicles (EV).

When such battery powered devices are used in high power regimes like quick acceleration in an EV or fast charging mobile phone batteries, (charging the battery completely in less than one hour or partial charging greater than 80% of the battery capacity in 30 minutes or less) the temperature rises quickly due to the heat generation from high currents (ohmic losses) and limits the batteries ability to deliver sustained power or accept more charge.

Overheating the battery is understood to result in catastrophic failures due to thermal runaways, fires and explosions. Battery management systems that control the charging and discharging of lithium ion batteries shut down the device operation to prevent rapid changes to the temperature (Shuai Ma et al.).

To overcome this limitation, bulky thermal management systems are used to keep the operation temperature of the batteries within the optimal temperature. The weight of these systems typically reduces the range of EVs by 40-50 percent.

A similar reduction in the range of an EV also occurs in a low temperature environment, such as at 10° C. or below. In particular, use of EVs in freeing conditions leads to a serious decrease in range (American Automobile Association, February 2019). At low temperatures, the chemical reactions within the battery proceed more slowly, and in freezing temperatures plating of metallic lithium can occur on a graphite anode (negative electrode) surface.

In addition, temperatures of 45° C. and greater have an effect of reducing the cycle life of the cell due to the degradation of the interfacial layer between the electrode material and the electrolyte called the solid electrolyte interface (SEI). This SEI layer which is usually formed on the anode material surface is responsible for stable operation of a lithium ion battery and the upper limit of 45° C. exists because at greater temperatures the SEI layer tends to decompose resulting in a drastic fade in capacity of the cell.

In light of the above challenges, there is a need to provide new electrode materials and surfaces for lithium ion batteries that are capable of operating at high rates and at high temperatures to extend the range of EV and allow for optimal battery function in portable battery powered devices in wider temperature ranges.

In light of the above challenges, there is a need to provide new electrode materials for lithium ion cells that are capable of operating at high or low temperatures.

### SUMMARY OF THE INVENTION

The invention generally provides an electrode having a niobium-containing metal oxide surface, an electrochemical cell comprising the electrode, and the use of the cell, for example in a lithium ion battery, at elevated or reduced temperatures.

The present inventors have established that high energy densities can be achieved using an electrode materials having a niobium-containing metal oxide surface in a lithium ion cell even when the cell is cycled at elevated or reduced temperatures. The cell displays excellent capacity retention when repeatedly cycled at elevated or reduced temperatures. Moreover, the cell can be charged and discharged at high C rates at both elevated and reduced temperatures. Thus, a lithium ion cell comprising an electrode having a niobium-containing metal oxide surface has a greater operational temperature range and shows improved cycle stability and elevated or reduced temperatures in comparison to a typical lithium ion cell comprising a graphite electrode.

Working electrodes having a niobium-containing metal oxide surface and bulk have favourable lithium diffusion properties, and thus exhibit superior rate performance. Above 1.0 V vs. Li+/Li, the formation of SEI is minimal, which means that lithium will not be lost into side reactions with the electrolyte.

A typical lithium-ion cell comprising a graphite electrode operates below 1 V vs Li+/Li and must undergo an initial formation cycle before the cell is sealed. Typically, this formation cycle takes place at elevated temperature, for example 60° C., in order to allow rapid formation of the SEI in one cycle and the degassing to occur. This adds signification time and cost to the cell manufacturing process.

In accordance with the present invention, the niobium-based metal oxide surface minimises or eliminates SEI formation normally observed on the graphite surface during the initial formation step in lithium ion batteries during the first charge cycle.

Furthermore, in a full cell against e.g. LiFePO₄, LiN(CF₃SO₂)₂ (LiTFSI) can be used to replace the more toxic LiPF₆ electrolyte salt commonly used in standard commercial electrolytes. Moreover, aluminium can be used as the current collector instead of the more expensive copper while avoiding LiAl alloying potentials (50.3 V vs. Li+/Li).

In general, the invention provides a method of charging and/or discharging an electrochemical cell, wherein the electrochemical cell comprises a working electrode having a niobium-containing metal oxide surface, and wherein the temperature of the electrochemical cell is 45° C. or more, such as 50° C. or more, 55° C. or more or 60° C. or more.

In general, the invention also provides a method of charging and/or discharging an electrochemical cell, wherein the electrochemical cell comprises a working electrode having a niobium-containing metal oxide surface, and wherein the temperature of the electrochemical cell is 10° C. or less, such as 5° C. or less or 0° C. or less.

In a first aspect of the invention, there is provided a method of charging and/or discharging an electrochemical cell, wherein the electrochemical cell comprises a working electrode having a surface layer of niobium-containing metal oxide disposed on a secondary active electrode material, and wherein the temperature of the electrochemical cell is 45° C. or more, such as 50° C. or more, 55° C. or more or 60° C. or more.

In a second aspect of the invention, there is provided a method of charging and/or discharging an electrochemical cell, wherein the electrochemical cell comprises a working electrode having a surface layer of niobium-containing metal oxide disposed on a secondary active electrode material, and wherein the temperature of the electrochemical cell is 10° C. or less, such as 5° C. or less or 0° C. or less.

The electrochemical cell may contain a counter electrode and an electrolyte, and optionally the electrodes are connectable to or are in connection with a power supply.

The method of either aspect may involve charging and/or discharging the electrochemical cell at a C rate of at least 5C, such as at least 10C, at least 20C, at least 30C, at least 40C at least 50C or at least 60C.

The method may involve a cycle of charging and discharging or discharging and charging the electrochemical cell, and the method may comprise 2 cycles or more, 5 cycles or more, 10 cycles or more, 50 cycles or more, 100 cycles or more, 500 cycles or more, 1,000 cycles or more, or 2,000 cycles or more.

The layer of niobium-containing metal oxide may have a maximum thickness of 4.5 nm or less.

The layer of niobium-containing metal oxide may be disposed on a particle of the secondary active electrode material. Alternatively, the layer of niobium-containing metal oxide may be disposed on a film of the secondary active electrode material.

The niobium-containing metal oxide may be selected from the different polymorphs of Nb₂O₅, NbO₂, Nb₂O₃ or combinations thereof.

The niobium-containing metal oxide may be doped with additional elements such as, phosphorus, aluminium, copper, chromium, zirconium, vanadium and lithium.

The niobium-containing metal oxide may be selected from a niobium tungsten oxide, a titanium niobium oxide, a niobium molybdenum oxide, or combinations thereof. Niobium vanadium oxide may also be used as the niobium-containing metal oxide.

The secondary active electrode material may be selected from carbon, silicon or a metal oxide. Lithium and silver may also be used as secondary active electrode materials.

The secondary active electrode material may be selected from graphite, reduced graphite oxide or hard carbon.

The secondary active electrode material may be selected from lithium titanate, titanium tantalum oxide or tantalum molybdenum oxide. Lithium vanadium oxide, lithium titanium silicate and lithium vanadium oxide phases may also be used as secondary active electrode material.

In a third aspect of the invention, there is provided an electrode, which may be referred to as a working electrode, having a niobium-containing metal oxide surface. The working electrode is suitable for use as an electrode in a lithium ion battery.

The working electrode comprises a surface layer of a niobium-containing metal oxide disposed on a secondary active electrode material.

The layer of niobium-containing metal oxide may be disposed on a particle of the secondary active electrode material. Alternatively, the layer of niobium-containing metal oxide may be disposed on a film of the secondary active electrode material.

The niobium-containing metal oxide may be selected from a Nb₂O₅ polymorph, NbO₂, Nb₂O₃ or combinations thereof.

The niobium-containing metal oxide may be doped with additional elements such as, phosphorus, aluminium, copper, chromium, zirconium, vanadium and lithium.

The niobium-containing metal oxide may be selected from a niobium tungsten oxide, a titanium niobium oxide, a niobium molybdenum oxide, or combinations thereof. Niobium vanadium oxide may also be used as the niobium-containing metal oxide.

The secondary active electrode material may be selected from carbon, silicon or a metal oxide. Lithium and silver may also be used as secondary active electrode materials.

The secondary active electrode material may be selected from graphite, reduced graphite oxide or hard carbon.

The secondary active electrode material may be selected from lithium titanate, titanium tantalum oxide and tantalum molybdenum oxide. Lithium vanadium oxide, lithium titanium silicate and lithium vanadium oxide phases may also be used as secondary active electrode material.

In a fourth aspect of the invention there is provided an electrochemical cell comprising the working electrode of the invention.

In a fifth aspect of the invention there is provided a lithium ion battery comprising one or more electrochemical cells of the invention. Where there are a plurality of cells, these may be provided in series or parallel.

In a sixth aspect of the invention there is provided the use of a working electrode having a surface layer of niobium-containing metal oxide disposed on a secondary active electrode material in an electrochemical cell, wherein the temperature of the electrochemical cell during charging or discharging 45° C. or more, such as 50° C. or more, 55° C. or more or 60° C. or more.

In a seventh aspect of the invention there is provided the use of a working electrode having a surface layer of niobium-containing metal oxide disposed on a secondary active electrode material in an electrochemical cell, wherein the temperature of the electrochemical cell during charging or discharging is 10° C. or less, such as 5° C. or less or 0° C. or less.

These and other aspects and embodiments of the invention are described in more detail below.

### SUMMARY OF THE FIGURES

FIG. 1 illustrates a working electrode particle having niobium-containing metal oxide surface layer with an intermediate metal oxide layer (top) and without an intermediate metal oxide layer (bottom).

FIG. 2A shows the rate performance of a NWO (Nb₁₆W₅O₅₅)/NMC (LiNi_{0.6}Co_{0.2}Mn_{0.2}O₂) cell as a function of the cell operation temperature at 60° C. (top), 25° C. (middle) and 10° C. (bottom).

FIG. 2B shows long-term cycle performance of a NWO/NMC cell at 60° C. under 10C rate.

FIG. 2C shows long-term cycle performance of a NWO/NMC cell at 25° C. (top) and 10° C. (bottom) under 5C rate conditions.

FIG. 2D shows rate performance comparison of a NWO/LFP cell as a function of temperature at 60° C. (top), 25° C. (middle) and 10° C. (bottom).

FIG. 2E shows long-term cycle performance of a NWO/LFP cell 10, 25, 60° C. under 5C rate.

FIG. 3A shows the rate performance of a cell comprising an anode having niobium-containing metal oxide surface layer disposed on a graphite secondary active material at 65° C. (top) and the rate performance of a cell comprising an anode leaching the niobium-containing surface layer (bottom) at 65 C.

FIG. 3B shows long-term cycle performance of the niobium-coated cell (top) and the uncoated cell (bottom) at 65° C.

FIG. 3C shows the rate performance of the niobium-coated cell at 65° C. (top) and 25° C. (bottom).

FIG. 3D shows the long-term cycle performance of the niobium coted cell at 65° C. (bottom) and 25° C. (top).

FIG. 4A is a scanning electron micrograph of primary particles of niobium-based metal oxides used in preparation of an anode according to an embodiment of the invention.

FIG. 4B a scanning electron micrograph of niobium-containing metal oxide coated onto irregular graphitic particles.

FIG. 4C a scanning electron micrograph of niobium-containing metal oxide coated onto irregular graphitic particles.

FIG. 4D a scanning electron micrograph of niobium-containing metal oxide coated onto regular graphitic particles FIG. 5A shows a pouch cell according to an embodiment of the invention.

FIG. 5B shows a cylindrical cell according to an embodiment of the invention.

FIG. 5C shows an anode electrode according to an embodiment of the invention coated on a current collector.

FIG. 5D shows anode and cathode electrodes in a jelly roll sound with a separator (left) to be placed inside a metal can (right) together with an electrolyte to make an electrochemical cell according to an embodiment of the invention.

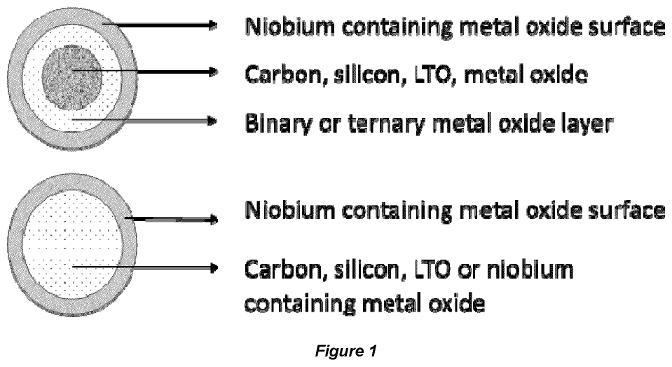

### DETAILED DESCRIPTION OF THE INVENTION

The invention generally provides an electrode having a niobium-containing metal oxide surface, an electrochemical cell comprising the electrode, and the use of the cell, for example in a lithium ion battery, at elevated or reduced temperatures.

Electrodes comprising niobium tungsten oxides have previously been described, for example, by Griffith et al. However, the electrochemical properties of niobium tungsten oxides were tested in a temperature-controlled room at 293±2 K using lithium metal as the counter electrode. The electrochemical properties have not been tested at elevated or reduced temperatures.

Electrodes consisting of an atomically thin coating comprising aluminium oxide (Al₂O₃) or titanium oxide (TiO₂) on a secondary active electrode material have also been reported (Lee Se-Hee et al U.S. Pat. No. 9,196,901 B2). However, the electrochemical properties of the coated electrodes have not been tested at elevated or reduced temperatures.

The present inventors have developed an electrochemical cell comprising an electrode having a niobium-counting metal oxide surface that has favorable lithium ion diffusion properties, high volumetric energy densities and high capacities even when cycled at elevated or reduced temperatures.

The voltage values described herein are made with reference to Li+/Li, as is common in the art.

The C-rate is a measure of the rate at which a battery is discharged relative to its maximum capacity. The C-rate may be defined as the inverse of the number of hours to reach a defined maximum capacity e.g., 10C corresponds to a 6 min discharge or charge time. The maximum capacity may be a theoretical maximum capacity or an empirically-determined maximum capacity. For example, a theoretical maximum capacity may be defined relative to one electron transfer per transition metal atom in the active electrode material.

High charging and discharging rates may also be described by reference to (gravimetric) current density relative to the weight of the electrode active material.

US 2017/0141386 describes the preparation of a negative electrode comprising a layer of LiNbO₃ coted on a conductive material (carbon black) and not on a secondary active electrode material. This teaches away from coating a secondary active electrode material with a niobium-containing metal oxide.

US 2019/0097226 describes the preparation of a niobium-containing positive electrode active material. The material is a single component and not disposed on a secondary active electrode material. This teaches away from a layered configuration, and from using niobium in the negative electrode.

EP 3522268 describes a positive electrode comprising a later of lithium niobate on a NMC active material. This teaches away from using niobium in the negative electrode.

US 2015/0221933 describes a positive electrode comprising an NMC active material having a niobium oxide compound sintered to a portion of the surface.

### Working Electrode

The invention provides a working electrode having a niobium-containing metal oxide surface. The working electrode is electrically conductive, and is electrically connectable to a counter electrode, for example within an electrochemical cell.

The working electrode may be an anode (negative electrode) or cathode (positive electrode) during a discharge step, for example in a lithium ion battery. Typically, the working electrode is the anode during a discharge step.

The working electrode has a niobium-containing metal oxide surface. That is, the surface of the working electrode terminates in a metal oxide comprising niobium (Nb). The niobium-containing metal oxide surface is the active electrode surface in an electrochemical cell. That is, the niobium-containing metal oxide surface is the surface contacting the electrolyte in a typical electrochemical cell.

The working electrode may comprise a layer of a niobium-containing metal oxide disposed on a secondary active electrode material. The layer of niobium-containing metal oxide may be a coating on the secondary active electrode material.

The thickness of the layer of niobium-containing metal oxide may be known, or it may be determined using standard techniques such as SEM.

In one embodiment, the layer of niobium-containing metal oxide may have a maximum thickness of 10 μm or less, for example 5 μm or less, 4 μm or less, 3 μm or less or 2 μm or less.

Preferably, the layer of niobium-containing metal oxide has a maximum thickness of 5 nm or less, for example 4.5 nm or less, 4.0 nm or less, 3 nm or less, or 2 nm or less.

The layer of niobium containing metal oxide may have a minimum thickness of 0.1 nm or more, for example 0.2 nm or more, 0.3 nm or more, 0.4 nm or more or 0.5 nm or more.

The niobium-containing metal oxide may have a thickness that is in a range selected from the maximum and minimum amounts given above. The inventors have found that thinner coatings of the niobium containing metal oxide are preferred as they have reduced impedance in comparison to thicker layers while maintaining the temperature stability of the electrode and mitigating SEI formation.

The layer of niobium-containing metal oxide may be disposed directly on the secondary active electrode material, or there may be an intermediate layer of active material.

The layer of niobium oxide may be disposed on a particle of the secondary active electrode material.

The size of the particle of the secondary active electrode material may be known, or it may be determined using standard techniques such as SEM.

The particle of the secondary active electrode material may have a maximum primary particle size of 100 μm or less, for example 50 μm or less, 40 μm or less, 30 μm or less or 20 μm or less.

The particle of the secondary active electrode material may have a minimum primary particle size of 5 nm or more, for example 10 nm or more, 15 nm or more, 20 nm or more, or 25 nm or more.

The particle of the secondary active electrode material may have a primary particle size that is in a range selected from the maximum and minimum amounts given above.

The particle shape may be regular or irregular.

Alternatively, the layer of niobium-containing metal oxide may be disposed on a film of the secondary active electrode material.

The thickness of the film of secondary active electrode material is not particularly limited.

Methods of coating a film or particle with a metal oxide are known and include chemical solution deposition, spin-coating, dip-coating, chemical vapour deposition, atomic layer deposition, molecular layer deposition, sputtering and physical vapour deposition.

Alternatively, the niobium-containing metal oxide surface may exist as a concentration gradient in a single material which comprises a niobium-rich surface layer and a niobium-poor interior.

The niobium-containing metal oxide may be selected from Nb₂O₅ polymorphs, NbO₂, Nb₂O₃ or combinations thereof.

The niobium-containing metal oxide may be doped with additional elements such as, phosphorus (P), aluminium (Al), copper (Cu), chromium (Cr), zirconium (Zr), vanadium (V) and lithium (Li).

The niobium-containing metal oxide may be lithium conductors such as lithium niobate (LiNbO₃), Li₃NbO₄ LiNbVO LiNbLaZrO (garnet family), LiNbSPO (LISICON family), LiNbAlTiP/LiNbAlGeP (NASICON family).

The niobium-containing metal oxide may be a mixture (for example, an amorphous mixture) of a niobium oxide and an additional metal oxide. Suitable additional metal oxides include titanium oxide, hafnium oxide, tantalum oxide or aluminium oxide. Vanadium oxide is also a suitable metal oxide.

The niobium-containing metal oxide may be a compound (for example, having a crystalline structure) of a niobium oxide and an additional metal oxide. Suitable niobium-containing metal oxides include niobium tungsten oxide (for example Nb₁₆W₅O₅₅ or Nb₁₈W₁₆O₉₃), a titanium niobium oxide (for example TiNb₂O₇), a niobium molybdenum oxide (for example Nb₂Mo₃O₁₄), or combinations thereof. A niobium vanadium oxide may also be used. Suitable niobium tungsten oxides include Nb₁₂WO₃₃, Nb₂₆W₄O₇₇, Nb₁₄W₃O₄₄, Nb₁₆W₅O₅₅, Nb₁₈W₈O₆₉, Nb₂WO₈, Nb₁₈W₁₆O₉₃, Nb₂₂W₂₀O₁₁₅, Nb₈W₉O₄₇, Nb₅₄W₈₂O₃₈₁, Nb₂₀W₃₁O₁₄₃, Nb₄W₇O₃₁, or Nb₂W₁₅O₅₀ or combinations thereof.

The secondary active electrode material is a material capable of reversible insertion of lithium ions (Li⁺).

The secondary active electrode material may be selected from carbon, silicon or a metal oxide. Lithium and silver may also be used as secondary active electrode materials.

The secondary active electrode material may be selected from graphite, reduced graphite oxide or hard carbon.

The secondary active electrode material may be selected from lithium titanate (LTO; Li₄Ti₅O₁₂), a titanium tantalum oxide (for example TiTa₂O₇) or a tantalum molybdenum oxide (for example Ta₈W₉O₄₇). Lithium vanadium oxide (for example LiV₃O₈), a lithium titanium silicate and lithium vanadium oxide phases may also be used as secondary active electrode material.

The working electrode may comprise a conductive carbon material to improve conductivity. The conductive carbon material may be carbon black, graphite, nanoparticulate carbon powder, carbon fibre and/or carbon nanotubes. The conductive carbon material may be Ketjen black or Super P carbon, or hard or soft amorphous carbon.

The working electrode may comprise a binder to improve adhesion of the active material to a current collecting surface. Examples of typically binders are PVDF, PTFE, CMC, PAA, PMMA, PEO, SBR and co-polymers thereof.

The working electrode is typically fixed to a current collector, such as a copper or aluminium collector, which may be in the form of a plate.

The inventors have assessed a working electrode comprising a niobium tungsten oxide (NWO) surface using an electrode configuration of 9:0.5:0.5 active material/carbon/binder with a 8-10 mg·cm⁻² loading of active material and a 1.27 cm² electrode area against a NMC or LiFePO₄ counter electrode in a 2032-type coin cell geometry and using 1.0 M LiPF₆ in ethylene carbonate/dimethyl carbonate as electrolyte.

The inventors have found that cycling the NWO/NMC cell for 300 cycles at 60° C. (10C rate) resulted in a loss of 30.8% of discharge capacity, while cycling the cell 10° C. (5C rate) showed a 15.5% capacity loss. Cycling the NWO/LFP cell for 1000 cycles 60° C. (5C rate) showed a 18.1% capacity loss, while cycling the cell at 10° C. (5C rate) showed a 6.9% capacity loss.

### Electrochemical Cell

The present invention also provides an electrochemical cell comprising a working electrode of the invention. The working electrode may be an anode or cathode during a discharge step, for example in a lithium ion battery. Typically, the working electrode is the anode during a discharge step.

The electrochemical cell typically comprises a counter electrode and an electrolyte. The electrochemical cell may comprise a current collecting plate. The electrochemical cell may be in electrical connection with a power supply. The electrochemical cell may be in electrical connection with a measurement device, for example an ammeter or voltmeter.

The electrochemical cell may be a lithium ion cell.

The counter electrode may be an anode or cathode during a discharge step, for example in a lithium ion battery. The counter electrode is typically the cathode during a discharge step.

Suitable cathode materials include lithium-containing or lithium-intercalated material, such as a lithium metal oxide, wherein the metal is typically a transition metal such as Co, Fe, Ni, V or Mn, or combination thereof. Some examples of positive electrode materials include lithium cobalt oxide (LiCoO₂), lithium nickel manganese cobalt oxide (NMC, LiNiMnCoO₂, e.g. LiNi_{0.6}Co_{0.2}Mn_{0.2}O₂), lithium vanadium fluorophosphate (LiVPO₄F), lithium nickel cobalt aluminum oxide (NCA, LiNiCoAlO₂), lithium iron phosphate (LFP, LiFePO₄) and manganese-based spinels (e.g. LiMn₂O₄).

The counter electrode may comprise a conductive carbon material to improve conductivity. The conductive carbon material may be carbon black, graphite, nanoparticulate carbon powder, carbon fibre and/or carbon nanotubes. The conductive carbon material may be Ketjen black or Super P carbon, or hard or soft amorphous carbon.

The counter electrode may comprise a binder to improve adhesion of the active material to a current collecting surface. Examples of typically binders are PVDF, PTFE, CMC, PAA, PMMA, PEO, SBR and co-polymers thereof.

The counter electrode is typically fixed to a current collector, such as a copper or aluminium collector, which may be in the form of a plate.

Typically, the electrolyte in the electrochemical cell is suitable for solubilising lithium ions.

Typically, the electrolyte in a charged and discharged cell contains lithium ions.

Typically, the electrolyte comprises lithium salts, such as LiTFSI, (bis(trifluoromethane)sulfonimide lithium salt, LiPF₆, LiBF₄, LiCIO₄, LiTF (lithium triflate) or lithium bis(oxalato) borate (LiBOB).

The electrolyte may be a liquid electrolyte, such as a liquid at ambient temperature, for example at 25° C. Preferred electrolytes are stable at elevated and reduced temperatures.

The electrolyte may be a non-aqueous electrolyte. The electrolyte may comprise a polar aprotic solvent. The electrolyte may comprise an organic solvent. Solvents for dissolving lithium ions are well known in the art.

Suitable solvents include carbonate solvents. For example propylene carbonate (PC), ethylene carbonate (EC), butylene carbonate (BC), chloroethylene carbonate, fluorocarbonate solvents (e.g., fluoroethylene carbonate and trifluoromethyl propylene carbonate), as well as the dialkylcarbonate solvents, such as dimethyl carbonate (DMC), diethyl carbonate (DEC), dipropyl carbonate (DPC), ethyl methyl carbonate (EMC), methyl propyl carbonate (MPC), and ethyl propyl carbonate (EPC).

Suitable solvents also include sulfone solvents. For example methyl sulfone, ethyl methyl sulfone, methyl phenyl sulfone, methyl isopropyl sulfone (MiPS), propyl sulfone, butyl sulfone, tetramethylene sulfone (sulfolane), phenyl vinyl sulfone, allyl methyl sulfone, methyl vinyl sulfone, divinyl sulfone (vinyl sulfone), di phenyl sulfone (phenyl sulfone), dibenzyl sulfone (benzyl sulfone), vinylene sulfone, butadiene sulfone, 4-methoxyphenyl methyl sulfone, 4-chlorophenyl methyl sulfone, 2-chlorophenyl methyl sulfone, 3,4-dichlorophenyl methyl sulfone, 4-(methylsulfonyl)toluene, 2-(methylsulfonyl) ethanol, 4-bromophenyl methyl sulfone, 2-bromophenyl methyl sulfone, 4-fluorophenyl methyl sulfone, 2-fluorophenyl methyl sulfone, 4-aminophenyl methyl sulfone, a sultone (e.g., 1,3-propanesultone), and sulfone solvents containing ether groups (e.g., 2-methoxyethyl(methyl)sulfone and 2-methoxyethoxyethyl(ethyl)sulfone).

Suitable solvents also include silicon-containing solvents such as a siloxane or silane. For example hexamethyldisiloxane (HMDS), 1,3-divinyltetramethyldisiloxane, the polysiloxanes, and polysiloxane-polyoxyalkylene derivatives. Some examples of silane solvents include methoxytrimethy Isilane, ethoxytrimethy Isilane, dimethoxydimethylsilane, methyltrimethoxysilane, and 2-(ethoxy)ethoxytrimethylsilane.

Typically, an additive may be included in the electrolyte to improve performance. For example vinylene carbonate (VC), vinyl ethylene carbonate, allyl ethyl carbonate, t-butylene carbonate, vinyl acetate, divinyl adipate, acrylic acid nitrile, 2-vinyl pyridine, maleic anhydride, methyl cinnamate, ethylene carbonate, halogenated ethylene carbonate, α-bromo-γ-butyrolactone, methyl chloroformate, 1,3-propanesultone, ethylene sulfite (ES), propylene sulfite (PS), vinyl ethylene sulfite (VES), fluoroethylene sulfite (FES), 12-crown-4 ether, carbon dioxide (CO₂), sulfur dioxide (SO₂), and sulfur trioxide (SO₃).

The electrochemical cell may also include a solid porous membrane positioned between the negative and positive electrodes. The solid porous membrane may partially or completely replace the liquid electrolyte. The solid porous membrane may comprise a polymer (e.g., polyethylene, polypropylene, or copolymer thereof) or an inorganic material, such as a transition metal oxide (e.g., titania, zirconia, yttria, hafnia, or niobia) or main group metal oxide, such as silicon oxide, which can be in the form of glass fiber.

The solid non-porous membrane may comprises a lithium-ion conductor. For example, LLZO (garnet family), LSPO (LISICON family), LGPS (thio-LISICON family), LATP/LAGP (NASICON family), LLTO (perovskite family) and phosphide/sulfide glass ceramics

### Methods

The invention provides a method of charging and/or discharging an electrochemical at elevated or reduced temperatures. The electrochemical cell comprises a working electrode niobium-containing metal oxide surface. Typically the electrochemical cell contains a counter electrode and an electrolyte.

Preferably the method is a method of charging and/or discharging an electrochemical cell at elevated temperatures (above ambient temperature; approximately 20° C.). For example, the method may be performed at 30° C. or more, such as 40° C. or more, 45° C. or more, 50° C. or more, 55° C. or more or 60° C. or more.

The inventors have found that a working electrode having a niobium-containing metal oxide surface can be stable up to 600° C. As such, the maximum temperature of the method of charging and/or discharging an electrochemical cell at elevated temperatures is defined by the choice of electrolyte and counter elected material. For example, an electrochemical cell comprising a working electrode having a niobium-containing metal oxide surface, a solid ceramic electrolyte and an LPF counter electrode is expected to cycle at 300° C.

Alternatively the method is a method of charging and/or discharging an electrochemical cell at reduced temperature (below ambient temperature; approximately 20° C.). For example, the method may be performed at 18° C. or less, such as 15° C. or less, 10° C. or less 5° C. or less or 0° C. or less.

The inventors believe that the minimum temperature of the method of charging and/or discharging an electrochemical cell at reduced temperatures is defined by the choice of electrolyte. With appropriate choice of electrolyte, the method of charging and/or discharging an electrochemical cell at reduced temperatures may take place at a minimum temperature of at least −70° C.

The method may be a method of charging and/or discharging an electrochemical cell at a current density of at least 750 mA·g⁻¹ such as at least 800 mA·g⁻¹. Preferably the method is a method of charging and/or discharging an electrochemical cell at a current density of at least 800 mA·g⁻¹, 850 mA·g⁻¹, 900 mA·g⁻¹, 950 mA·g⁻¹, 1000 mA·g⁻¹, 1050 mA·g⁻¹, 1100 mA·g⁻¹, 1200 mA·g⁻¹ or 1300 mA·g⁻¹.

The method may involve a cycle of charging and discharging or discharging and charging the electrochemical cell. The cycle may be repeated more than once. Thus, the method comprises 2 cycles or more, 5 cycles or more, 10 cycles or more, 50 cycles or more, 100 cycles or more, 500 cycles or more, 1,000 cycles or more, or 2,000 cycles or more.

### Battery

The present invention also provides a battery comprising one or more electrochemical cells of the invention. The battery may be a lithium ion battery.

Where there are a plurality of cells, these may be provided in series or parallel. A battery of the invention may be provided in a road vehicle, such as an automobile, moped or truck. Alternatively, a battery of the invention may be provided in a rail vehicle, such as a train or a tram. A battery of the invention may also be provided in an electric bicycle (e-bike), a drone, an electric aircraft, and an electric or hybrid boat. Similarly, batteries of the invention may be provided in power tools such as powered drills or saws, garden tools such as lawnmowers or grass trimmers, or home appliances such as tooth brushes or hair dryers.

A battery of the invention may be provided in a regenerative braking system.

A battery of the invention may be provided in a portable electronic device, such as a mobile phone, laptop or tablet.

A battery of the invention may be provided in a power grid management system.

### Uses

The invention generally provides the use of a working electrode having a niobium-containing metal oxide surface in an electrochemical cell, such as an electrochemical cell as described herein. Typically, the temperature of the electrochemical cell during charging or discharging is 45° C. or more, such as 50° C. or more, 55° C. or more or 60° C. or more. Alternatively, the temperature of the electrochemical cell during charging or discharging is 10° C. or less, such as 5° C. or less or 0° C. or less.

The working electrode may find use in the methods described herein.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### EXPERIMENTAL

The following examples are provided to illustrate the present invention and are not intended to limit the scope of the invention.

### Example 1

Synthesis of Nb₁₆W₅O₅₅

Nb₁₆W₅O₅₅ (NWO) was synthesized by co-thermal oxidation of NbO₂ (Alfa Aesar, 99+%) or white Nb₂O₅(Sigma, 99.9985%) with WO₂ (Alfa Aesar, 99.9%) in approximately one to five gram batches. The partially reduced oxides were massed to within 0.001 g of the 16:5 molar ratio, ground together by hand with an agate mortar and pestle, pressed into a pellet at 10 MPa, and heated in a platinum crucible at a rate of 10 K·min⁻¹ to 1473 K, and naturally cooled in the furnace over about 2 hours. The NWO powder was confirmed to be phase-pure by X-ray diffraction.

### Electrode Preparation

NMC-662 was obtained from Targray USA. Super P (TIMCAL) and polyvinylidene fluoride (PVdF; Kynar) dispersed in N-methyl-2-pyrrolidone were used as a conducting material and binder, respectively. All slurries were composed of 90% active material, 5% super P and 5% PVdF binder, and the mixing was conducted with a Thinky mixer 250. The NMC and LFP electrodes were dried in an oven at 80° C. for 2 h in a dry room, and the NWO electrodes were dried in an oven at 60° C. overnight under ambient atmosphere. All electrodes were calendared at room temperature, the electrodes loadings were 8.0-8.3 mg/cm² (NMC), 8.4-8.7 mg/cm² (LFP) and 8.8-9.4 mg/cm² (NWO).

### Electrochemical Characterisation

All electrochemical measurements were evaluated with 2032-type stainless steel coin cells. Prepared cathode and anode electrodes were dried at 100° C. for 3 h under vacuum, then transferred into an argon-filled glove box (MBraun) without exposure to air. Half and full cells were assembled in the glove box with LP30 electrolyte (Sigma-Aldrich), which is composed of 1.0 M lithium hexafluorophosphate (LiPF₆) in ethylene carbonate (EC): dimethyl carbonate (DMC) (1:1 v/v). A polyethylene separator (Toray) was used after drying at 40° C. for 2 h under vacuum. For electrolyte analyses, glass fibre filter (Whatman, GE) was used as the separator. The filter was also dried at 150° C. under vacuum in a drying oven (Buchi). Galvanostatic electrochemical tests were conducted at various current densities by using a galvanostat/potentiostat (BioLogic) in a temperature-controlled oven at 10, 25 and 60° C. All testing cells have negative to positive capacity ratio of 1.1-1.2, which is calculated based on the practical capacities of the active materials, i.e. 171.3 mAh/g for NWO, 175 mAh/g for NMC and 165 mAh/g for LFP. Full cell capacities in this study are calculated by active material mass of cathode. For symmetrical cell tests, two full cells having the same loading were operated at 0.2C, and impedance was measured at 2.0 V during the charging step. Frequencies from 1 MHz to 100 mHz were scanned with an applied amplitude of 10 mV. Afterwards, cells were disassembled in the glove box, and two symmetric cells were assembled with fresh LP30 electrolyte. Electrochemical impedance was measured again on the symmetric cells under the same conditions.

### Characterisation of Electrodes

For characterisation, cells were disassembled and rinsed with DMC, then fully dried at pre-chamber under vacuum. X-ray diffraction patterns of pristine and cycled electrodes were obtained in transmission mode from an X-ray diffractometer (Empyrean, Panalytical) at ambient temperature with a Cu Kα source. Lattice parameters, phase and purity of the material were determined by Rietveld refinement using the Fullprof software.

### Thermal Stability

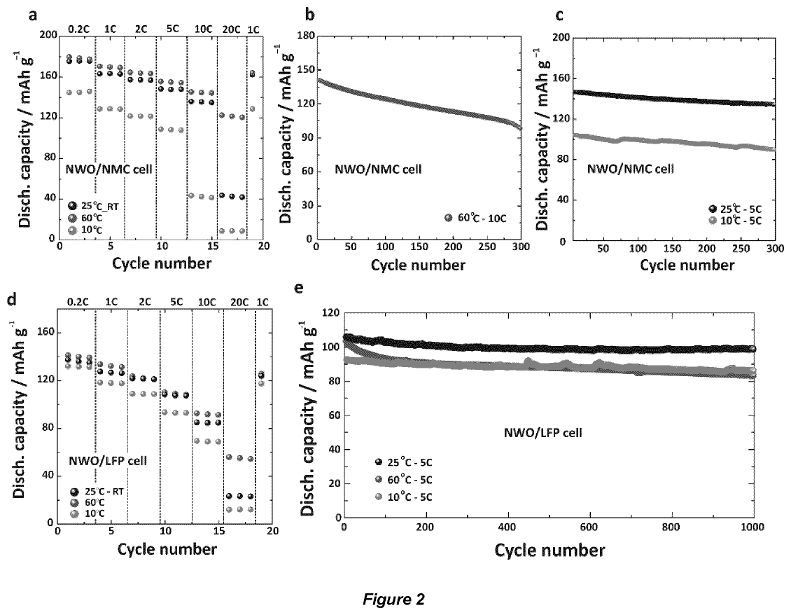

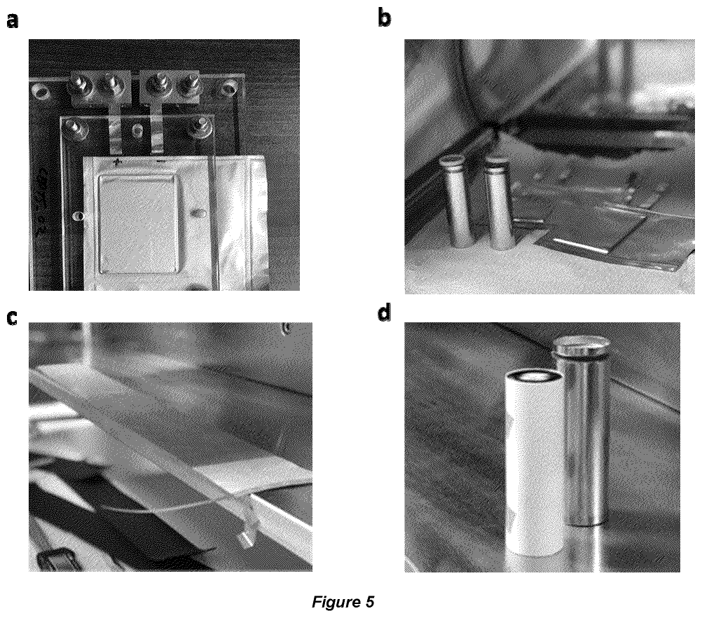

The thermal performance stability of the NWO/NMC and NWO/LFP cells was tested at 10, 25 and 60° C. (FIG. 2). From both cells, discharge capacities of cells tested at different C-rates at 60° C. (10° C.) show relatively higher (lower) values compared to 25° C. These phenomena are likely related to the kinetics of charge transfer and diffusion reactions in the cell. Long-term cycling performance of NWO/NMC cell was evaluated for 300 cycles under three different conditions: 10C at 60° C. (FIG. 2b) and 5C at 10 and 25° C. (FIG. 2c). Cell cycling at 60° C. (10C) resulted in a loss of 30.8% of discharge capacity while the cells at 25° C. (5C) and 10° C. (5C) show 9.2% and 15.5% capacity loss. Variable-temperature cycling of NWO/LFP cell was conducted for 1000 cycles at 5C rate. At temperatures of 10, 25 and 60° C. (FIG. 2e), 6.9%, 7.9% and 18.1% capacity loss was observed over 1000 cycles, respectively. This indicates that the NWO/LFP combination has better cycling stability and operational temperature range than NWO/NMC with the electrolyte used here.

### Example 2

Multiple cells were constructed with different capacity in the range of 0.1Ah to 5Ah. The anodes comprised platelet like graphite having a lithium niobium oxide surface layer. A slurry of 92% active material, 3% conductive material and 5% binder (PVDF or SBR/CMC) was prepared and mixed and deposited as a coating on a current collector such as aluminium or copper. This was paired with a cathode that contained a lithium metal oxide such as NMC622 or N811 and wound with a separator based on polypropylene or polyethylene to obtain a jelly roll (see FIG. 5).

The jelly roll is placed in a metal can or pouch (FIG. 5) and filled with electrolyte that contains a lithium salt such as LiPF₆ and sealed. The sealed cell is charged with an external power supply in a constant current, constant voltage mode to charge the cell to a desired voltage such as 3V or 4.2V and then discharged by constant current to 1V or 0V.

For a 1Ah cell, 1C is equal to a charge or discharge current of 1A and will completely charge/discharge the cell in 1 h. At 2C, the same cell will charge/discharge in 0.5 hr, and at 0.5C in 2 hrs. The cycling data is generated by varying the C-rate or current that is put in to the cell during charging or obtained from the cell during discharging.

### Thermal Stability

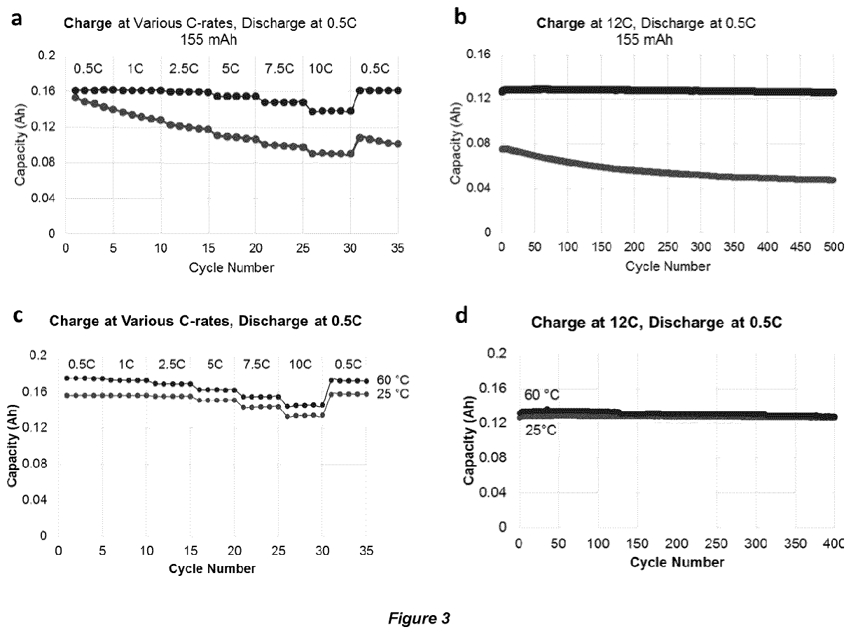

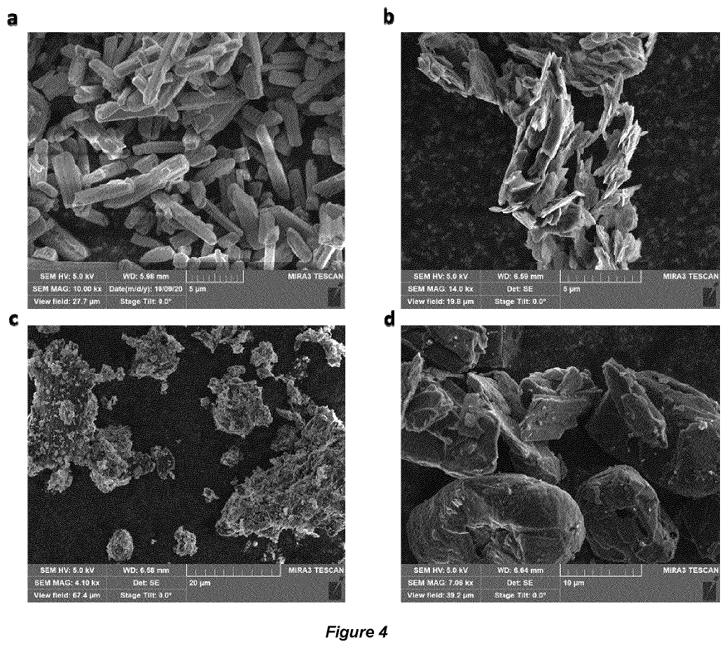

FIG. 3 provides the thermal performance stability for a cell having a capacity of 0.16Ah. The cell is tested at 65° C. against a cell lacking the lithium niobium oxide surface layer. The discharge rate is 0.5C (155 mhA) and charge rate varied between 0.5C to 10C (FIG. 3a). The cell comprising the uncoated anode shows a capacity loss of close to 50% at 10C charging, while the cell comprising an anode having a surface niobium-containing metal oxide layer shows a capacity loss of less than 15% at 10C. Long-term cycling performance of the coated cell is evaluated for 500 cycles under a 12C charging and 0.5C discharge regime (FIG. 3b). The uncoated cell shows close to 50% loss in capacity over 500 cycles at 65° C. In contrast, the cell comprising the coated anode shows very little capacity loss (less than 5%) over 500 cycles at 65° C.

FIGS. 3c and 3d provide a comparison between cycling at 60° C. and 25° C. for the cell comprising the lithium niobium coated anode. It can be seen that cell cycling at the C-rates tested results in only a 20% capacity loss (FIG. 3c) and capacity is largely retained over 400 cycles (FIG. 3d). This indicates that the niobium-containing metal oxide coated anode cells have excellent cycling stability at elevated temperatures in comparison to the uncoated anode cell.

### ADDITIONAL EXAMPLES

Additional cells were constructed in which the negative electrode composition included platelet like graphite having a niobium tungsten oxide surface. The cells also had excellent cycling stability at elevated temperatures.

### REFERENCES

Temperature effect and thermal impact in lithium-ion batteries: A Review, Progress in Natural Science: Materials International, Shuai Ma et al., December 2018).
Electric Vehicle Range Testing: AAA proprietary research into the effect of ambient temperature and HVAC use on driving range and MPGe, American Automobile Association, February 2019 Niobium tungsten oxides for high-rate lithium-ion energy storage, Griffith et al. Nature, Vol 559, pp. 556-559.
Nano-engineered coatings for anode active materials, cathode active materials, and solid-state electrolytes and methods of making batteries containing nano-engineered coatings, Albano, et al., US 2016/0351973.
Inoue et al., US 2013/0266858
Kashimura, EP 3522268
Kawasaki, et al. US 2019/0097226
Mizawa, et al., US 2015/0221933
Waseda, et al., US 2017/0141386

1. A method of charging and/or discharging an electrochemical cell, wherein the electrochemical cell comprises a working electrode having a surface layer of niobium-containing metal oxide disposed on a secondary active electrode material, and wherein a temperature of the electrochemical cell is 45° C. or more, or wherein the temperature of the electrochemical cell is 10° C. or less.

2. The method of claim 1, wherein the temperature of the electrochemical cell is 50° C. or more, or the temperature of the electrochemical cell is 5° C. or less.

3. The method of claim 1, wherein the working electrode is an anode.

4. The method of any of claim 1, wherein the layer of niobium-containing metal oxide has a maximum thickness of 4.5 nm or less.

5. The method of claim 1, wherein the niobium-containing metal oxide is selected from a Nb₂O₅ polymorph, NbO₂, Nb₂O₃ or combinations thereof.

6. The method of claim 1, wherein the niobium-containing metal oxide is doped with an element selected from phosphorus, aluminium, copper, chromium, zirconium, vanadium and lithium.

7. The method of claim 1, wherein the niobium-containing metal oxide is selected from a niobium tungsten oxide, a titanium niobium oxide, a niobium molybdenum oxide, a niobium vanadium oxide or combinations thereof.

8. The method of claim 1, wherein the layer of niobium-containing metal oxide is disposed on a particle of the secondary active electrode material.

9. The method of claim 1, wherein the layer of niobium-containing metal oxide is disposed on a film of the secondary active electrode material.

10. The method claim 1, wherein the secondary active electrode material is selected from carbon, silicon or a metal oxide.

11. The method of claim 10, wherein the secondary active electrode material is selected from graphite, reduced graphite oxide or hard carbon.

12. The method of claim 10, wherein the secondary active electrode material is selected from lithium titanate, titanium tantalum oxide, tantalum molybdenum oxide and lithium vanadium oxide.

13. The method of claim 1, wherein the method is a method of charging and/or discharging an electrochemical cell at a C rate of at least 5C.

14. The method claim 1, wherein the method comprises a cycle of charging and discharging, or discharging and charging the electrochemical cell.

15. The method of claim 14, wherein the method comprises 2 cycles or more, 5 cycles or more, 10 cycles or more, 50 cycles or more, 100 cycles or more, 500 cycles or more, 1,000 cycles or more, or 2,000 cycles or more.

16. A working electrode comprising a surface layer of a niobium-containing metal oxide disposed on a secondary active electrode material.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. The method of claim 1, wherein the temperature of the electrochemical cell is 50° C. or more, or the temperature of the electrochemical cell is 5° C. or less.

32. The method of claim 1, wherein the working electrode further comprises a conductive carbon material.

33. The method of claim 1, wherein the niobium-containing metal oxide is a niobium tungsten oxide, niobium molybdenum oxide, or a combination thereof.

34. The method of claim 1, wherein the method comprises charging and/or discharging an electrochemical cell at a current density of at least 750 mA·g⁻¹.
